(19) United States
(12) Patent Application Publication
(10) Pub. No.: US 2022/0239711 A1
(43) Pub. Date: Jul. 28, 2022

(54) CREATION OF CONFERENCE INSTANCE WITH DIFFERENTIAL CAPABILITIES AND NATIVE TOOLS ACCORDING TO THE CONFERENCE ORIGIN EVENT'S ATTRIBUTES

(71) Applicant: Avaya Management L.P., Durham, NC (US)

(72) Inventors: Prasanna Kulkarni, Pune (IN); Nayana Teja Avatapalli, Eluru (IN); Shrikant Jadhav, Pune (IN); Dileep Kumar Pandey, Sultanpur (IN); Renato Rodrigo Resende, Suzano (BR); Alessandro Badin, São Paulo (BR); Eduardo Croys Felthes Neto, Barretos (BR); Victor Hugo Rodrigues Vieira, Joinville (BR); Vinicius Rigoni Hernandes, Campinas (BR)

(21) Appl. No.: 17/155,900

(22) Filed: Jan. 22, 2021

(51) Int. Cl. H04L 29/06; G06N 20/00

(52) U.S. Cl. CPC H04L 65/403; G06N 20/00

(57) ABSTRACT

Electronic conferences provide a means by which people who are not co-located may interact, such as to solve a problem. As described herein, an event (e.g., an email or automatically generated message reporting a fault or abnormal state) of a monitored system may provide an input into a conferencing system that, based on the event, automatically invites and configures resources required to resolve the cause of the event. Resources may be human resources automatically connected to the convergence via a communication device and/or software resources (e.g., tools, applications) necessary to investigate, resolve, and apply a resolution to the system.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for ad hoc conferences and particularly to event-triggered configuration of such conferences.

### BACKGROUND

Every day numerous electronic conferences are conducted for a specific purpose. Once the purpose is satisfied, the electronic conference is considered complete and terminated. These electronic conferences are formed upon the occurrence of a certain event and the purpose of the conference is “handling” that event. For example, a component encountered an error or fault occurred (e.g., an event) and the purpose is to resolve the error or fault or provide another remedy.

This is a common occurrence in computational/networking production support. Here, up-time is often critical and 24x7 monitoring provided to various components and systems. A failure or interruption in any critical service needs immediate attention and warrants a conference with subject matter experts for that. These experts often require the assistance of other experts in the same conference to resolve the issue. After investigation and corrective action taken to fix the problem which caused the failure event, the conference ends.

### SUMMARY

As it is known in the prior art, an event exists or does not exist and the event itself has no impact on the conference capabilities provided by the prior art conferencing applications. For example, prior art applications provide services to enable various multi-media capabilities, such as recording the conference, mute participant, raise hand, screen share etc. However, as described herein, conferences are improved by configuring features of the conference based on a particular event or event attribute.

As an example, a Kuberentes production cluster is operational where product A is deployed running on Pod-A. If Pod-A crashes, such as due to an OutOfMemory error, and automatic measures to restart the pod have failed then human intervention is required. As the root of the problem, or the resolution, may not be initially known and may require a conference to debug and resolve this issue. For example, a problem may originate in a misconfiguration or fault in software, hardware, data storage networking, or other component or the interconnections therebetween. If there is an invitee who is called on-demand (e.g., R&D developer), generally such on-demand invitees do not have access to the underlying environment. If such a developer needs to run a command, he/she needs to pass it on to support persons having access and to the system to enter and run the command.

These and other needs are addressed by the various embodiments and configurations of the present invention. The present invention can provide several advantages depending on the particular configuration. These and other advantages will be apparent from the disclosure of the invention(s) contained herein.

In one embodiment, a conference is provided with the features determined by the product and/or environment that is witnessing the problem and/or the occurrence of a particular event or attribute of an event. By altering the configuration to selectively include, or not include, features such as audio control, screen share, recording, and/or other features, the conference may be better suited to facilitate the types and forms of communication required.

In other embodiments, specific tools are differentiated and associated with particular event or product and implemented. For example, one event may require a log viewer whereas another event does not, and resources could be saved by only implementing the required tools. An event may be evaluated and based on information extracted from the event, an invitee list generated for the conference. In another embodiment, the conference may be configured with audio and/or text interface (e.g. chat box) to communicate with other participants and as a pseudo-shell for issuing commands to one or more external systems and present information from external systems back to the conference. Embodiments herein may be provided by a conference connector service that integrates the conferencing system with the one or more system external to the conferencing system.

In another embodiment, the initial configuration of users, tools, etc. may be modified, such as upon determining that the issue should be escalated. Escalation may be determined automatically (e.g., no resolution after a previously determined period of time, a subsequent failure or degradation of services after an attempted resolution, speech/text from users indicates uncertainty or exhaustion of options, etc.) and/or manually, such as by entering “escalate” into the chat box. As a result, the conferencing space may be reconfigured, such to invite/connection other users, add additional tools, and/or reconfigure existing tools (e.g., allow more features), etc.

In another embodiment, the conference connector services maintain the conference session ID to the event and, accordingly, makes event specific Command Line Interface (CLI) tools available in the conference session. The conference connector service may optionally access an artificial intelligence (AI) agent (e.g., Google Dialogflow) created with event specific “intent” and the make the agent available in the conference session to help resolve the issue. As it is known in the art of AI agents, an “intent” categorizes an end-user's intention for one conversation turn. For each agent, many intents may be defined, where the combined intents can handle a complete conversation. When an end-user writes or says something, referred to as an end-user expression, the expression is matched to the best intent in your agent.

In another embodiment, upon conference completion/dismissal or if a host overrides the configuration, the conference connector service removes some or all of the tools accessed, such as to revert the conference to a traditional electronic conference.

In another embodiment, the conference connector service configures on-demand tool access policy to distinguish between users and provide a subset of tools to users as per the users' access level.

In another embodiment, the conference connector service may limit the functionality of a tool available to the conference that would otherwise be available.

A conference connector service may configure a conference in accordance with an event attribute. Configuration options include, auto-invite participants relevant to the event; enable tools relevant to the event (e.g., tools that would not be otherwise available); add dynamic role-based access controls for enabled tools; restrict functionality of a tool available via the conferencing interface; enable conference chat controls to interface with external system relevant to the event. Application programming interface (API) may be utilized to enable/configure a conference's features, perform tasks, and/or tool functionality.

Certain embodiments disclosed herein are further illustrated with respect to the following example which utilizes Avaya Spaces as a conferencing system and a Kubernetes implementation that provides an event indicating a failure. In the example, a conference connector receives the failure event from Kubernetes (an example of a system external to the conferencing system) cluster, such as an OutOfMemoryError on Pod-A. The conference connector listens (e.g., an software/hardware agent configured to receive events, retrieve events wrote to a log, and/or otherwise become aware of the event as they occur and/or have previously occurred) and determines that this is a failure event and a conference would be needed to resolve this issue. The conference connector examines the event and/or Pod metadata and takes following actions: invite or connect subject matter experts (SMEs) that have expertise, authority, or are otherwise necessary to identify the cause of the issue, determine a solution, and/or implement the solution to resolve the issue; access the list of all additional tools that need to be made available in the conference, and external systems access to enable these tools; apply an configurations to the additional tools (e.g. intents for bots); apply any filters to the tools output before presenting the output in conference; and load any default settings or states when the conference is created.

The resulting conference has logs of Pod A included, participants invited/connected, and a listener attached to this conference to listen to all the text messages as they're typed in conference chat box. A user invited to the conference types in commands in chat box, which may comprise a predefined syntax (e.g., “kubectl get pods”). The conference connector listens this command, check whether the command is allowed and whether the user issuing this command is allowed to run it. If both conditions are met, the conference connector, connects to the appropriate Kubernetes cluster where the event occurred and runs the command on the cluster. Results are collected and posted back to the chat-box.

The conference connector looks at the user-issued commands, and determines if the command is allowed. For example, an environment state change command (e.g., kubectl drain node) will not be allowed and the conference connector returns an appropriate error message. As a benefit the exposure of a command interface (e.g., kubectl) may be filtered, such as by permissions, to only allow a subset of operations. Additionally or alternatively, certain tools may be entirely eligible/ineligible based on the event type and/or configured permissions. For example, if the event is about a Session Manager, the resultant conference session chat would entertain “traceSM” commands, and present its output in conference but if the user issues “traceABCD” command, it would not be recognized as a valid command as it is not a valid command for the session manager.

The conference connector may determine if a custom tool, such as a chatbot, should be deployed and configured based on the event, such as to provide additional information based on content spoken/typed. For example, if a user puts any Kubernetes query or stack-trace, conf-connector can query to Google Dialogflow agent configured to understand Kubernetes question intent and accordingly query external locations. (Kubernetes documentation site, Slack channel etc.). The query result would be posted back in conference chat interface or any other suitable interface of conference. Similarly, if the question is about the Session Manager, the conference connector then configures automated agents to search in for typed/spoken content in the Session Manager product documentation and provide search results back in the conference.

Events may also be reported by a user, such as a customer, sending a text message, email, phone message, etc. The message is analyzed, which may comprise speech-to-text conversion for voice messages, and a process flow initiated. The message itself is parsed for data related to the issue (e.g., products affected, severity, attempts by the user to resolve the issue, etc.). A team or an individual may be associated with the issue and invited/connected to a dynamically created conferencing space (e.g., Avaya Spaces). Information may be extracted, such as by AWS Lambda and submitted to a messaging service, such as AWS SQS. The event may be automatically classified by an automated agent (e.g., Google Dialogflow) to identify team members, task checklists, etc. and invitations links and/or automatic connections provided using a communication platform (e.g., Avaya's CPaaS). Additionally or alternatively, a conferencing space may be preserved or recorded, such as to make the history readily available for subsequent use or analysis.

Exemplary aspects are directed to:

A system for automatically configuring and initiating a conference, comprising: a data storage comprising a non-transitory media; a processor; and a network interface to a network; and wherein the processor is configured by machine-readable instructions maintained in a non-transitory storage to cause the processor to: receive an event via the network, wherein the event originates from a monitored system; parse the event to obtain a number of attributes; access a rule from the data storage; evaluate the rule to determine specific users required to resolve the event, wherein the rule is selected based on the value of the number of attributes; and initiate the conference comprising connections, via the network, to a number of communication devices associated with the users determined from the rule.

A method for automatically configuring and initiating a conference, comprising: receiving an event via a network, wherein the event originates from a monitored system; parsing the event to obtain a number of attributes; accessing a rule from the data storage; evaluating the rule to determine specific users required to resolve the event, rule is selected based on the value of the number of attributes; and initiating the conference comprising connections, via the network, to a number of communication devices associated with the users determined from the rule.

A conferencing server, comprising: a data storage comprising a non-transitory media; a processor; a network interface to a network; and wherein the processor is configured by machine-readable instructions maintained, in a non-transitory storage to cause the processor to: receive an event via the network, wherein the event originates from a monitored system; parse the event to obtain a number of attributes; access a rule from the data storage; evaluate the rule to determine specific users required to resolve the event, wherein the rule is selected based on the value of the number of attributes; initiate the conference comprising connections, via the network, to a number of communication devices associated with the users determined from the rule, wherein the server is initiated with default features common to all conferences and at least one non-default feature, selected in accordance with the rule; and receiving a chat message from one of the number of communication devices and providing the chat message to at least one other of the number of communication devices, when determined to be a communication, and to at least one software application when determined to be a command.

Any of the above aspects:

Wherein the instructions further cause the processor to: evaluate the rule to determine a configuration of the conference comprising at least one non-default feature; and initiate the conference comprising enabling the at least one non-default feature.

Wherein the instructions further cause the processor to: evaluate the rule further indicating a required software application; and at least one of access or launch the required software application and presenting the software application interface to the conference.

Wherein the software application comprises a software tool configured to perform at least one of accessing data from the monitored system, diagnosing a fault in the monitored system, altering an operational parameter of the monitored system, receiving a command for execution by the monitored system, or reporting an output from the monitored system.

Wherein the instructions further cause the processor to: receive, from one of the number of communication devices, a communication input to the chat interface; determine whether the communication input comprises a communication or a command; the processor, upon determining the input comprises the communication, provides the communication to at least one other of the number of communication devices; and the processor, upon determining the input comprises the command, provides the command to the software application.

Wherein the instructions further cause the processor to present an output from the software application via the chat interface.

Wherein the software application comprises a plurality of software applications, wherein each of the plurality of software applications comprise a discrete command interface; and the instructions further cause the processor to determine whether the communication input, when determined to comprise the command, further determines whether the command comprises a command for a first of the plurality of software applications, providing the command to the first software application; and the instructions further cause the processor to determine whether the communication input, when determined to comprise the command, further determines whether the command comprises a command for a second of the plurality of software applications, providing the command to the second software application.

Wherein the instructions further cause the processor to access a configuration from the data storage and apply the configuration to the software application.

Wherein the instructions further cause the processor to enable a chat interface between the number of communication devices to enable communication, via the network, between the users.

Wherein the instructions further cause the processor to: evaluate the event and, at a subsequent time, determine if an escalation is required; and upon determining an escalation is required, automatically adding at least one escalation user, adding at least one escalation software application, or adding at least one escalation feature to the software application.

Wherein at least one, but less than all of the users, comprise an artificially intelligent user.

Wherein evaluating the rule to determine a configuration of the conference comprising at least one non-default feature; and initiating the conference comprising enabling the at least one non-default feature.

Wherein evaluating the rule further indicating a required software application; and at least one of accessing or launching the required software application and presenting the software application interface to the conference.

Wherein the software application comprises a software tool configured to perform at least one of accessing data from the monitored system, diagnosing a fault in the monitored system, altering an operational parameter of the monitored system, receiving a command for execution by the monitored system, or reporting an output from the monitored system.

Further comprising receiving, from one of the number of communication devices, a communication input to the chat interface; determining whether the communication input comprises a communication or a command; upon determining the input comprises the communication, providing the communication to at least one other of the number of communication devices; and upon determining the input comprises the command, providing the command to the software application.

Further comprising presenting an output from the software application via the chat interface.

Wherein the software application comprises a plurality of software applications, wherein each of the plurality of software applications comprise a discrete command interface; and upon determining whether the communication input, when determined to comprise the command, further determines whether the command comprises a command for a first of the plurality of software applications, providing the command to the first software application; and upon determining the communication input, when determined to comprise the command, further determines whether the command comprises a command for a second of the plurality of software applications, providing the command to the second software application.

Further comprising initiating the at least one non-default feature comprising the software application or a particular configuration of the software application in accordance with the rule.

A system on a chip (SoC) including any one or more of the above aspects.

One or more means for performing any one or more of the above aspects.

Any one or more of the aspects as substantially described herein.

Any of the above aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

The term “conference” refers to exclusively to electronic conferences and, unless explicitly noted otherwise, excludes in-person meetings between humans. The conference comprises a virtual meeting space between participants utilizing electronic devices connected to a network to participate in the conference. Such conferences comprise one or more of voice, video, text chat, data sharing, application sharing, and/or other conferencing operations (e.g., raise hand, speaker control, connect/disconnect—accept/drop participants, mute/unmute, etc.).

It should also be appreciated that the term “event” refers to an occurrence of an operation (or lack of operation) or state (or lack of a state) on a monitored component or system that is reported by the monitored component or system and/or another component or system. The event may indicate that an occurrence did occur (e.g., an error) or did not occur (e.g., an expected operation), when expected or that an operational parameter is outside a nominal range. For example, a database server may encounter an abnormality or failure and report the abnormality or failure as an event. In another example, a server attempts to access a database server and is unable and reports the lack of access as an event. In another example, a dedicated monitoring component monitors the database server and determines that the rate at which operations have performed has dropped below a threshold value. And in yet another example, a first and second database are load-sharing database services. If a first server experiences an unusual spike in activity, this may be reported as an event, such as an event indicating that the second database server has, partially or completely, failed. Events may be reported by computational components, networking components (e.g., routers, switches, hubs, etc.), security components, data storage components, and client devices. In certain other embodiments, other devices, such as electro-mechanical devices, sensors, probes, etc., may also report events (e.g., server cabinet has an above-threshold temperature event, earthquake sensor, a robot arm is drawing above-normal power, etc.).

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a process in accordance with embodiments of the present disclosure;

FIG. 4 depicts a data structure in accordance with embodiments of the present disclosure;

and

FIG. 5 depicts a third system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

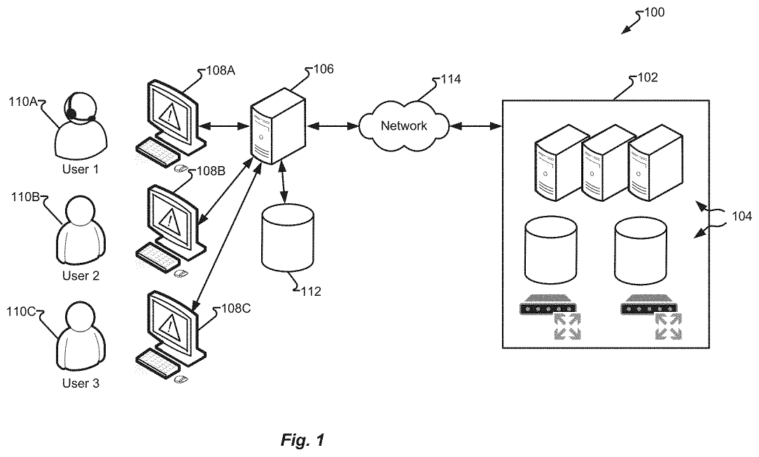

FIG. 1 depicts system 100 in accordance with embodiments of the present disclosure. In one embodiment, monitored system 102 comprises a number of monitored components 104. Monitored components 104 may be computing devices, communication devices, data storage devices, sensors, probes, dedicated monitoring equipment, and/or other component capable of performing a task and self-monitoring or be monitored by a monitoring component. Additionally or alternatively, a function of monitored components 104 may be monitored as a discrete task. For example, a software application may encounter an error or enter an abnormal state and, as a result output an event. In yet another embodiment, a user, such as on-site personnel may observe the fault or abnormal state and manually report the event, such as via an email, call, or text to a vendor or technical support personnel.

The event is received by server 106. It should be appreciated that server 106 may consist of a stand-alone processing unit (e.g., server), as illustrated, or in other embodiments be integrated into monitored system 102, one or more of monitored components 104, and/or one or more of user communication device 108. Additionally, the particular topology illustrated comprising network 114 and a number of nodes communicating thereon (e.g., user communication device 108A-C, monitored system 102, server 106) is not exhaustive of all topologies and individual nodes may be attached to network 114 and/or other network to form other communication network topologies without departing from the scope of the embodiments described herein.

In the case of a manually reported event, user 110A may type (speak or otherwise input) details of the event into user communication device 108A and thereby input the event into server 106. When automatically reported, such as by monitored system 102 comprising monitoring hardware or a specific one or more of monitored components 104, server 106 receives the event communicating with server 106 via network 114 (e.g., Internet, ethernet, public switched telephone network, etc.).

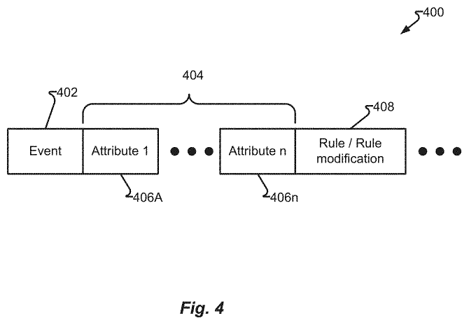

Server 106, now with the event, accesses data storage 112, such as to obtain a rule from a data structure (see FIG. 4) maintained therein. The data structure comprising a number of rules for selection based upon the particular event(s) and/or attributes of the event. The selection of a particular rule may be based on a previously configured record. Additionally or alternatively, the rule may be previously configured via a neural network trained to evaluate events and their required resources for resolution, and the results thereof stored in the data structure, or dynamically determined (e.g., real-time) by such a neural network.

Server 106, upon examination of the event and/or event attribute(s), selects a rule, which may comprise generating a rule, identifying the resources to include in a conference to resolve the issue that caused the event. The resource may include humans, such as user 110B and user 110C, which may be subject matter experts (SMEs) for one or more monitored components 104 and/or monitored system 102, or otherwise have skills and attributes (e.g., authority) necessary to gather, diagnose, and/or apply a resolution to monitored system 102. Accordingly, user 110B and user 110C may be invited or, as a further embodiment, automatically connected to the conference utilizing user communication device 108B and user communication device 108C, respectively. It should be appreciated that any user communication device 108 comprises a network interface to a network, such as network 114, to send and receive communications, such as one or more of voice, video, text, documents, images, etc.

Server 106, as specified by the rule selected, may also launch or access software applications. The software applications may be an artificially intelligent agent or other tool, such as a data acquisition tool, modeling tool, command line interface tool, etc., to enable the gathering of necessary data, determining a resolution, and/or applying the resolution that caused the event. As a further option, tools may be configured based upon the rule selected in accordance with the event. For example, features of a tool may be granted based on permissions which, if not determined to be necessary, may have a potential to do more harm to monitored system 102. In contrast, if has features essential to the resolution of the event, then such features may be automatically enabled by server 106.

Once the conference is underway, the participants (e.g., users 110) may utilized the enabled tools and tool features to debug the issue and apply a resolution to monitored system 102. When the issue is, in whole or in part, a hardware issue (e.g., physical failure of a component) a user, such as one of users 110 or a different user may be instructed to apply the necessary fix.

In another embodiment, server 106 may determine if the fault was or was not successfully resolved and apply such findings to a new rule or a modified rule maintained in a data structure of data storage 112. For example, if a particular event was reported to server 106 from monitored system 102 and, in accordance with the rule, users 110A and 110C are added to the conference with Tool A, Tool B, and Tool C, and the problem was successfully resolved (e.g., the fault or abnormal condition reported as the event no longer exists), but Tool B was never used and, initially excluded user 110B, was added to the conference, then server 106 may modify the rule to exclude unused tools (e.g., drop Tool B from the rule) and add necessary user communication device 108B (to include user 110B) for a future encounter of the error. Similarly, conference features may be selectively added beyond a set of default features common for all conferences based on the rule, such as recording, screen sharing, etc. However, if more features are added and used, or features added are not used, then the rule may be modified to only include such conferencing features as were previously determined to be necessary. The conference may be provided with a session identifier and re-established, such as if the event occurs again. In addition to the resources utilized, a recording of the conversations, issued commands, and received responses may be included in the conference, such as via text chat box or other event log.

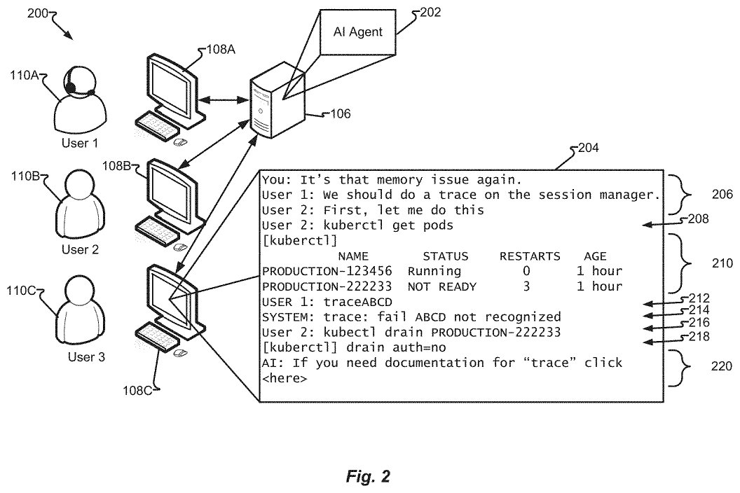

FIG. 2 depicts system 200 in accordance with embodiments of the present disclosure. System 100 may include additional features, such as those of system 200. Features omitted from system 200 are done so for illustrative purposes to avoid unnecessarily complicating the figure. In one embodiment, system 200 comprises an automated agent, such as artificial intelligent (AI) agent 202. AI agent 202 may analyze events, event attributes, state of monitored system 102, a monitored components 104, what is spoken/typed into text chat 204, and/or access external sources of information (e.g., documents, wiki, etc.) and provide findings conference participants, such as user 110A-C. AI agent 202 may be executed by a processor of server 106 and/or other component (not shown) included in the conference.

Accordingly, and in another embodiment, one or more user communication device 108A-C may be configured with a conferencing application comprising text chat 204. It should be appreciated that text chat 204 may be a transcription of speech provided by users 110 into the conference and/or other inputs. For example, chat portion 206 comprises communications provided by ones of users 110, via their respective user communication device 108, into the conference and presented to the other users 110 via their respective user communication devices 108. In another embodiment, server 106 may execute a conferencing connector to serve as an interface between text chat 204 and a target hardware or software portion of monitored components 104. As a result, command 208 may be entered into text chat 204 and response 210 provided via text chat 204 for presentation to each user communication device 108 engaged in the conference.

Not all commands entered into text chat 204 may be successfully executed. For example, command 212 (“traceABCD”) may result in the conferencing connector determining that the command is not understood by any software application (e.g., such as a diagnostic tool, or command interface) configured for the conference. In response, reply 214 may report that the command is not recognized. Similarly, command 216 may be recognized, but response 218 reported back from the associated software application indicating that the command cannot be processed, such as due to a lack of authorization.

Returning to AI agent 202, which may be monitoring text chat 204 and the contents thereof, may suggest a remedy, such as indicating a possible action to take, solution, or suggesting reference material in response 220.

In another embodiment, some or all of the above factors (e.g., the event, the tools/configuration, the conferencing tools/configurations, the users included) and suggestions provided by AI agent 202 may utilized AI decision making, such as machine learning, deep learning, neural network, etc. to seeded to produce an accurate, and continually improving, outcome describing the “how” a particular conference should be configured to effectively address the issue that caused the event.

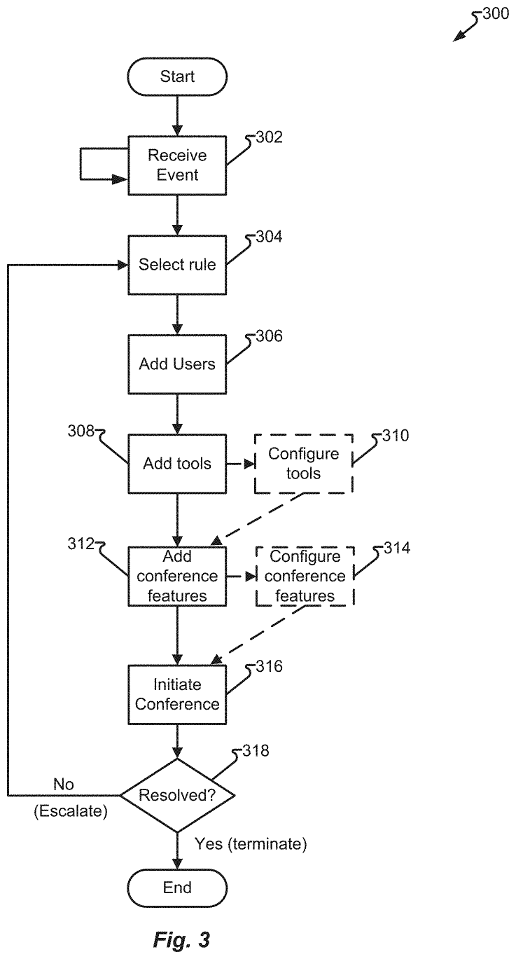

FIG. 3 depicts process 300 in accordance with embodiments of the present disclosure. In one embodiment, process 300 may be embodied as a set of machine-executable instructions maintained in a non-transitory storage media for execution by at least one processor, such as a processor of server 106. Process 300 begins and, in step 302, receives an event. Step 302 may execute as a loop to receive events intermittently or continually. Next, step 304 selects a rule, such as by parsing the event to extract event attributes. Step 304 may select a rule entirely from a data structure (see FIG. 4), from the data structure but modified, or generated, such as by a neural network trained to determine the resources required to address a particular event.

Additionally or alternatively, a machine learning model uses prior events, the resources used, and their resolution (or lack of resolution) during a prior conference to identify an initial rule or rule portion for in step 304. The machine learning model may be or may include any resource (e.g., specific user, user attribute, software application, software application configuration, conference feature, etc.) that was included in a conference or utilized to resolve a particular event. The machine learning may allow events determined to be more similar to those events requiring one set of resources, when encountered again, may select similar resources. If a resolution fails (e.g., resolved via other means) or based on the time required for the underlying issue to be resolved, such resources may be de-emphasized as having less (or no) benefit to resolving the event. The machine learning model may be or may include any learning algorithm(s), such as, a linear regression algorithm, a logistic regression algorithm, a decision tree algorithm, a Naïve Bayes algorithm, a K-means algorithm, and/or the like.

In accordance with the rule, step 308 adds users. In one embodiment, step 308 automatically connects to a communication device (e.g., user communication device 108) of an associated user (e.g., user 110) and thereby include the user into the conference. In another embodiment, step 306 may automatically send an invite, such as a text, audio, or email message to allow the user to initiate participation in the conference.

Tools and conference features are also included in accordance with the rule. It should be appreciated that the term “tool” refers to a software application that is, or is determined likely, necessary to, in whole or in part, obtain relevant data, diagnose, resolve, model, and/or apply a resolution to resolve the issue reported in the event received in step(s) 302. For example, step 308 adds any required tools to the conference. This may include providing an icon to a direct interface or, as discussed above, configure a conference connector executing on server 106 to accepts commands into text chat 204 for the tool. Step 308 may proceed to step 312 or optionally to step 310 wherein tools are configured (e.g., addresses applied for certain monitored components 104, features selectively enable/disabled, etc.) based on the event and resulting rule. While all conference may have certain features enabled (e.g., chat/talk between users) other features may be determined based on a rule. For example, step 312 may enable a video feature when a particular event is associated with a camera image (e.g., a visual event that occurred with one of monitored components 104). Similarly, other features enabled may include, the ability to invite other users, recording of the conference, desktop sharing, etc.) Process 300 may proceed to step 316 or optionally step 314 wherein conference features are configured (e.g., only certain users/types of users may invite other users, desktop sharing is enabled only for a subset of users, etc.). At step 316 the conference is initiated.

Test 318 may automatically determine if the issue has been resolved, such as by receiving an event indicating a return to normal operation for a component(s) associated with the original event. If the issue is resolved, test 318 is determined in the affirmative and process 300 may end. If test 318 is determined in the affirmative, processing may optionally loop back, such as to step 304 to select a new rule and execute additional steps of process 300, such as to add additional users to the conference or add additional tools/features to enable additional resources required. It should be appreciated that test 318 may be accompanied by an escalation event received at a particular iteration of step 302. For example, if an abnormal situation is worsening or a time for resolution has passed without successful resolution, an event may be self-generated within process 300 to trigger the escalation steps.

In another embodiment, some or all of the above factors (e.g., the event, the tools/configuration, the conferencing tools/configurations, the users included) may be input into a machine learning algorithms seeded to produce an accurate, and continually improving, outcome describing the “how” a particular conference should be configured to address the issue that caused the event.

FIG. 4 depicts data structure 400 in accordance with embodiments of the present disclosure. In one embodiment, data structure 400 may be maintained as records in a database and further maintained in data storage 112 or otherwise made accessible to a processor of server 106, such as to select a rule in step 304 (see FIG. 3). Data structure 400 comprises event field 402, such as to maintain an event identifier, name, or other indicia of an event. Attribute field 404 comprises a number of attribute fields 404A-406n. Attribute fields 406 may be populated by server 106 parsing an event and extracting attributes. Attributes may include time, place, associated hardware, associated software, processes, severity, attempted automatic resolutions, and/or other features of an event. A match between all, or a designated portion of attributes 406, may indicate a particular rule identified in rule field 408. Rule field 408 may indicate a single or number of rules to be selected (see FIG. 3, step 304).

In one embodiment, at least one attribute field 406 may comprise a customer identifier wherein a particular user 110 must always be included in the conference (e.g., a customer engineer for the customer). This may be in addition to any other rule. Additionally a single attribute field 406 field, or a combination of attributes, may be associated with users, tools, features, configurations, etc. identified in rule field 408 that are to be included in a conference initiated in response to a particular received event.

Optionally, data structure 400 may comprise additional fields as a matter of design choice.

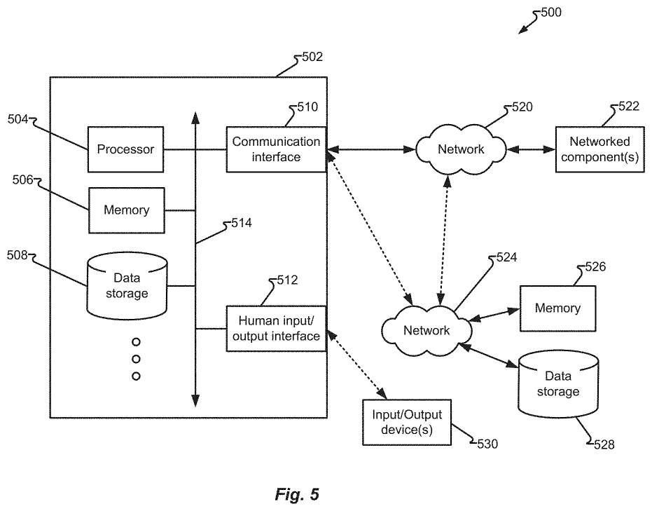

FIG. 5 depicts device 502 in system 500 in accordance with embodiments of the present disclosure. In one embodiment, server 106 and/or one or more of user communication device 108 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize memory 506 and/or data storage 508 for the storage of accessible data, such as instructions, values, etc. Communication interface 510 facilitates communication with components, such as processor 504 via bus 514 with components not accessible via bus 514. Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, etc. In another embodiment, communication interface 510 may comprise, or be comprised by, human input/output interface 512. Communication interface 510 may be configured to communicate directly with a networked component or utilize one or more networks, such as network 520 and/or network 524.

Network 114 may be embodied, in whole or in part, as network 520. Network 520 may be a wired network (e.g., Ethernet), wireless (e.g., WiFi, Bluetooth, cellular, etc.) network, or combination thereof and enable device 502 to communicate with network component(s) 522. In other embodiments, network 520 may be embodied, in whole or in part, as a telephony network (e.g., public switched telephone network (PSTN), private branch exchange (PBX), cellular telephony network, etc.)

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) that networked components 522, which may be connected to network 520 comprising a public network (e.g., Internet) that may not be as trusted.

Components attached to network 524 may include memory 526, data storage 528, input/output device(s) 530, and/or other components that may be accessible to processor 504. For example, memory 526 and/or data storage 528 may supplement or supplant memory 506 and/or data storage 508 entirely or for a particular task or purpose. For example, memory 526 and/or data storage 528 may be an external data repository (e.g., server farm, array, “cloud,” etc.) and allow device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of memory 506, data storage 508, memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, switch, port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system for automatically configuring and initiating a conference, comprising:
a data storage comprising a non-transitory media;
a processor;
a network interface to a network; and
wherein the processor is configured by machine-readable instructions maintained in a non-transitory storage to cause the processor to:
receive an event via the network, wherein the event originates from a monitored system;
parse the event to obtain a number of attributes;
access a rule from the data storage;
evaluate the rule to determine specific users required to resolve the event, wherein the rule is selected based on the value for the number of attributes;
evaluate the rule to further determine at least one non-default feature of a conference not enabled for default conferences and wherein the non-default feature comprises as least one of session recording, screen sharing, or video communications; and
initiate the conference comprising connections, via the network, to a number of communication devices associated with the users determined from the rule and enabling the at least on non-default feature.

2. (canceled)

3. The system of claim 1, wherein the instructions further cause the processor to:
evaluate the rule further indicating a required software application; and
at least one of access or launch the required software application and presenting the required software application interface to the conference.

4. The system of claim 3, wherein the required software application comprises a software tool configured to perform at least one of accessing data from the monitored system, diagnosing a fault in the monitored system, altering an operational parameter of the monitored system, receiving a command for execution by the monitored system, or reporting an output from the monitored system.

5. The system of claim 3, wherein the instructions further cause the processor to:
receive, from one of the number of communication devices, a communication input to the chat interface;
determine whether the communication input comprises a communication or a command;
the processor, upon determining the input comprises the communication, provides the communication to at least one other of the number of communication devices; and
the processor, upon determining the input comprises the command, provides the command to the software application.

6. The system of claim 5, wherein the instructions further cause the processor to present an output from the required software application via the chat interface interspersed with chat messages from the number of communication devices associated with the users.

7. The system of claim 5, wherein:
the required software application comprises a plurality of software applications, wherein each of the plurality of software applications comprise a discrete command interface;
the instructions further cause the processor to determine whether the communication input, when determined to comprise the command, further determines whether the command comprises a command for a first of the plurality of software applications, providing the command to the first software application; and
the instructions further cause the processor to determine whether the communication input, when determined to comprise the command, further determines whether the command comprises a command for a second of the plurality of software applications, providing the command to the second software application.

8. The system of claim 3, wherein the instructions further cause the processor to access a configuration from the data storage and apply the configuration to the software application.

9. The system of claim 1, wherein the instructions further cause the processor to enable a chat interface between the number of communication devices to enable communication, via the network, between the users.

10. The system of claim 1, wherein the instructions further cause the processor to:
evaluate the event and, at a subsequent time, determine if an escalation is required; and
upon determining an escalation is required, automatically adding at least one escalation user, adding at least one escalation software application, or adding at least one escalation feature to the software application.

11. The system of claim 1, wherein at least one, but less than all of the users, comprise an artificially intelligent user.

12. A method for automatically configuring and initiating a conference, comprising:
receiving an event via a network, wherein the event originates from a monitored system;
parsing the event to obtain a number of attributes;
accessing a rule from the data storage;
evaluating the rule to determine specific users required to resolve the event, wherein the rule is selected based on the value of the number of attributes, wherein at least one but less than all of the users comprise an artificially intelligent user; and
initiating the conference comprising connections, via the network, to a number of communication devices associated with the users determined from the rule.

13. The method of claim 12, wherein:
evaluating the rule to determine a configuration of the conference comprising at least one non-default feature; and
initiating the conference comprising enabling the at least one non-default feature.

14. The method of claim 12, further comprising:
evaluating the rule further indicating a required software application; and
at least one of accessing or launching the required software application and presenting the required software application interface to the conference.

15. The method of claim 14, wherein the required software application comprises a software tool configured to perform at least one of accessing data from the monitored system, diagnosing a fault in the monitored system, altering an operational parameter of the monitored system, receiving a command for execution by the monitored system, or reporting an output from the monitored system.

16. The method of claim 14, further comprising:
receiving, from one of the number of communication devices, a communication input to the chat interface;
determining whether the communication input comprises a communication or a command;
upon determining the input comprises the communication, providing the communication to at least one other of the number of communication devices; and
upon determining the input comprises the command, providing the command to the software application.

17. The method of claim 16, further comprising presenting an output from the required software application via the chat interface.

18. The method of claim 17, wherein:
the required software application comprises a plurality of software applications, wherein each of the plurality of software applications comprise a discrete command interface;
upon determining whether the communication input, when determined to comprise the command, further determines whether the command comprises a command for a first of the plurality of software applications, providing the command to the first software application; and
upon determining the communication input, when determined to comprise the command, further determines whether the command comprises a command for a second of the plurality of software applications, providing the command to the second software application.

19. A conferencing server, comprising:
a data storage comprising a non-transitory media;
a processor;
a network interface to a network; and
wherein the processor is configured by machine-readable instructions maintained in a non-transitory storage to cause the processor to:
receive an event via the network, wherein the event originates from a monitored system;
parse the event to obtain a number of attributes;
access a rule from the data storage;
evaluate the rule to determine specific users required to resolve the event, wherein the rule is determined by the number of attributes;
initiate the conference comprising connections, via the network, to a number of communication devices associated with the users determined from the rule, wherein the server is initiated with default features common to all conferences and at least one non-default feature, selected in accordance with the rule and wherein the non-default feature comprises at least one of session recording, screen sharing, or video communications; and
receiving a chat message from one of the number of communication devices and providing the chat message to at least one other of the number of communication devices, when determined to be a communication, and to at least one software application when determined to be a command.

20. The conferencing server of claim 19, further comprising initiating the at least one non-default feature comprising the at least one software application or a particular configuration of the at least one software application in accordance with the rule.

21. The conferencing server of claim 19, wherein at least one, but less than all of the users, comprise an artificially intelligent user.
